(19) United States
(12) Patent Application Publication
(10) Pub. No.: US 2019/0093776 A1
(43) Pub. Date: Mar. 28, 2019

(54) BURST DISK ASSEMBLY FOR HIGH AND ULTRA HIGH VACUUM CONTAINMENT VESSELS

(71) Applicant: ACCU-GLASS PRODUCTS, INC., Valencia, CA (US)

(72) Inventor: ANDRES L. LIGETI, LIVERMORE, CA (US)

(21) Appl. No.: 15/716,840

(22) Filed: Sep. 27, 2017

(51) Int. Cl. F16K 17/16

(52) U.S. Cl. CPC F16K 17/16; F16K 17/40

(57) ABSTRACT

An improved burst disc assembly for use in pressure relief conduits for high vacuum and ultra-high vacuum containment vessels, the assembly having a body with inlet and outlet openings connected by an internal passage, a burst disc disposed within the internal passage and connected therein to hermetically isolate the inlet and outlet openings. The assembly further has a mounting structure connected to the body and outwardly extending therefrom that may be clamped between adjacent faces of a pair of metal seal flanges provided in the relief conduit to secure the assembly in position and hermetically seal the assembly in the conduit in a manner prohibit the passage of gas molecules from the surrounding environment into the containment vessel through the relief conduit. The mounting structure is formed from a soft metal material having substantially lower hardness value than that of the metal seal flange faces to enable adequate sealing. The connection between the mounting structure and the body further provides similar hermetic seal. Upon rupture of the burst disc, the assembly alone must be replaced while the metal seal flanges connecting the burst disc assembly to the containment vessel may be reused.

### BACKGROUND OF THE INVENTION

This invention relates generally to pressure protection of high vacuum and ultra-high vacuum containment vessels, and more particularly to a cartridge-style rupture disc for installation between a mating pair of CF type metal seal flanges.

Burst discs are commonly used in high vacuum (HV) and ultra-high vacuum (UHV) systems as a means of protecting a vacuum vessel or chamber against accidental over-pressurization. They are designed to burst or rupture at a predetermined and calibrated relief pressure when the pressure inside the protected vacuum vessel exceeds the specified relief pressure. Burst discs are one-time use safety devices which must be discarded and replaced after use (failure).

The conventional method for incorporating a burst disc in a HV or UHV system is to provide a burst disc mounted in a fixture incorporating an industry standard ConFlat® (CF) type metal seal flange which allows connection to a CF flange provided on the containment vessel. Once the burst disc is ruptured the entire assembly, including the CF metal seal flange, must be scrapped as it is no longer serviceable even though the metal seal flange itself remains undamaged. Advantages would be realized by a burst disc assembly that could be installed in a conventional CF flange interface in a manner that prevented the leakage of gas at the molecular level necessary for HV and UHV applications while minimizing the material to be scrapped upon rupture of the disc. Additional advantages would be realized by a burst disc assembly that could be easily installed within existing containment vessel relief piping without the need to modify the piping or connections.

### SUMMARY OF THE INVENTION

Accordingly, the present invention, in any of the embodiments described herein, may provide one or more of the following advantages:

It is an object of the present invention to provide an improved burst disc assembly for use on a vacuum containment vessel subjected to high vacuum or ultra-high vacuum conditions that may be installed using conventional metal seal flanged connections without requiring the flanged connections to be scrapped upon rupture of the burst disc.

It is another object of the present invention to provide a burst disc assembly having a body with a burst disc that may be disposed entirely within a relief conduit for a vacuum containment vessel, the assembly further having a mounting structure outwardly extending from the body that may be clamped and sealed between adjacent faces of a pair of CF metal seal flanges wherein the installed assembly prohibits the passage of gas molecules from the surrounding environment to the vacuum containment vessel. The mounting structure is formed from a soft metal material having substantially lower hardness value than that of the flange seal faces to enable UHV hermetic sealing. The connection between the mounting structure and the body must also provide similar molecular-level gas sealing.

It is a further object of the present invention to provide a burst disc assembly for high vacuum and ultra-high vacuum containment vessels that is easily removed following rupture and replaced with an assembly that is easy to install with consistent leakage performance.

It is a still further object of the present invention to provide an improved burst disc assembly for high vacuum and ultra-high vacuum containment vessels that minimizes waste following a disc rupture thereby improving economic efficiency. Eliminating a metal seal flange from the assembly achieves this objective.

It is a still further object of the present invention to provide an improved burst disc assembly for high vacuum and ultra-high vacuum containment vessels that is durable in construction, inexpensive of manufacture, carefree of maintenance, easily assembled, and simple and effective to use.

These and other objects are achieved in accordance with the present invention by a burst disc assembly having a body with a burst disc contained therein that may be disposed entirely within a relief conduit for a vacuum containment vessel. The assembly further has a mounting structure connected to the body and outwardly extending therefrom that may be clamped between adjacent faces of a pair of metal seal flanges provided in the relief conduit to secure the assembly in position and prohibit the passage of gas molecules from the surrounding environment to the containment vessel. The mounting structure is formed from a soft metal material having substantially lower hardness value than that of the flange seal faces to enable UHV hermetic sealing. The connection between the soft metal mounting structure and the body further provides similar molecular-level gas sealing. Upon rupture of the burst disc, the assembly alone must be replaced while the flanges connecting the assembly to the vessel may be reused.

### BRIEF DESCRIPTION OF THE DRAWINGS

The advantages of this invention will be apparent upon consideration of the following detailed disclosure of the invention, especially when taken in conjunction with the accompanying drawings wherein:

FIGS. 1 and 2 illustrate a conventional burst disc assembly for use in a high vacuum or ultra-high vacuum containment vessel;

FIG. 3 an exploded view of the improved burst disc assembly invention as it is installed in a relief conduit for a high vacuum or ultra-high vacuum containment vessel;

FIG. 4 is a side view of the improved burst disc assembly;

FIG. 5 is a cut-away view of the improved burst disc assembly of FIG. 4;

FIG. 6 is cut-away view of the improved burst disc assembly as it is installed in a relief conduit for a high vacuum or ultra-high vacuum containment vessel;

FIG. 7 provides a detail view of the mount and seal interface between the burst disc assembly and the relief conduit; and

FIG. 8 provides an alternate installation the burst disc assembly as used in a closed venting system in which the outboard piping is directed to a secondary containment vessel or container.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “up” or “down,” or “top” or “bottom” are used as a matter of mere convenience, and are determined with reference to ground. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all figures.

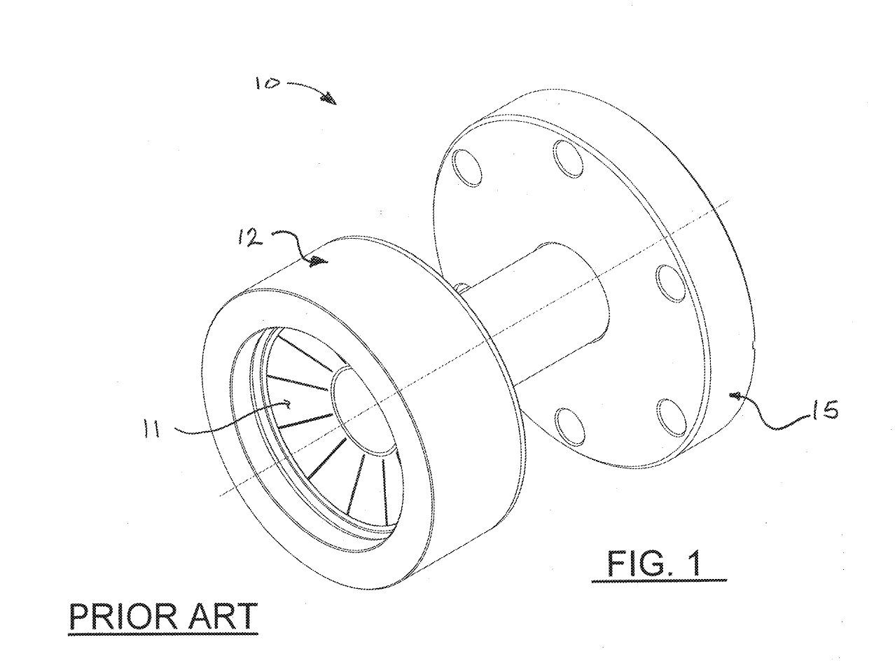

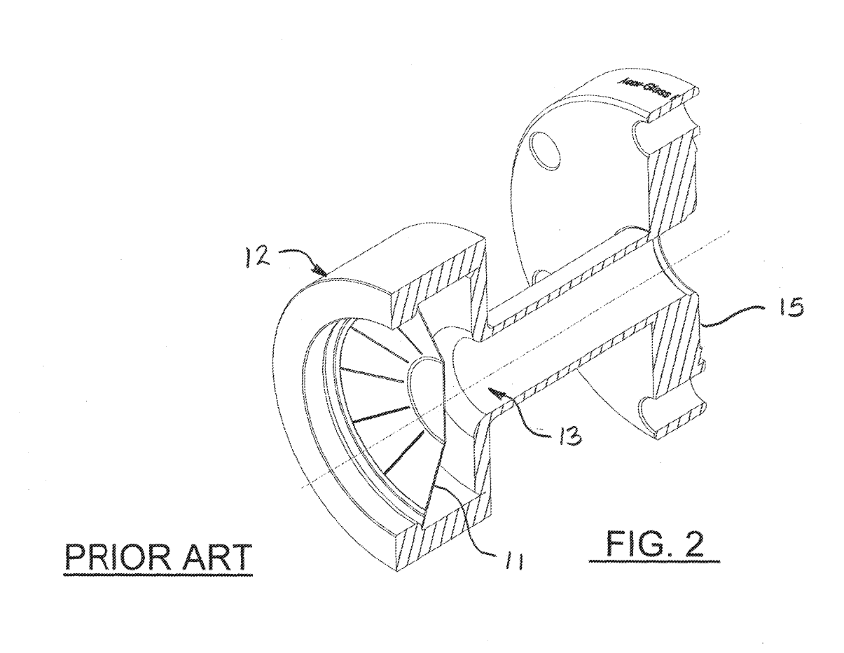

Referring to FIGS. 1 and 2, a conventional burst disc assembly 10 used for over-pressure protection of a high vacuum (HV) or ultra-high vacuum (UHV) is illustrated. The prior art assembly 10 includes a burst disc membrane 11 mounted in an internal conduit 13 extending through a body 12. The connection between the disc membrane 11 and the body creates a hermetic seal that prevent the passage of gas through the conduit while the membrane remains intact. The body 12 further includes a metal seal flange 15 which enables the assembly 10 to be connected to a matching metal seal flange (not shown) provided on a pressure relief conduit of a containment vessel (not shown) in a manner positioning the disc membrane in fluid communication with the containment vessel interior. Mechanical connections to vacuum containment vessels are unique to high vacuum service applications as they are required to create a hermetic seal between the containment vessel and the surrounding environment. One exemplar mechanical connection is the^{ConFlat}® (CF) type metal seal flange which utilized opposing parallel faces, each having a sealing structure encircling the internal opening in the flange, and a gasket compressed between the faces. The sealing structure is in the form of a knife edge projecting from the flange face. The gasket is formed from a comparatively softer material so that the knife edges plastically deform the gasket material as the flanges are drawn together to create the seal. Following an overpressure event in the containment vessel that causes actuation of the burst disc membrane 11, the entire burst disc assembly 10 must be scrapped.

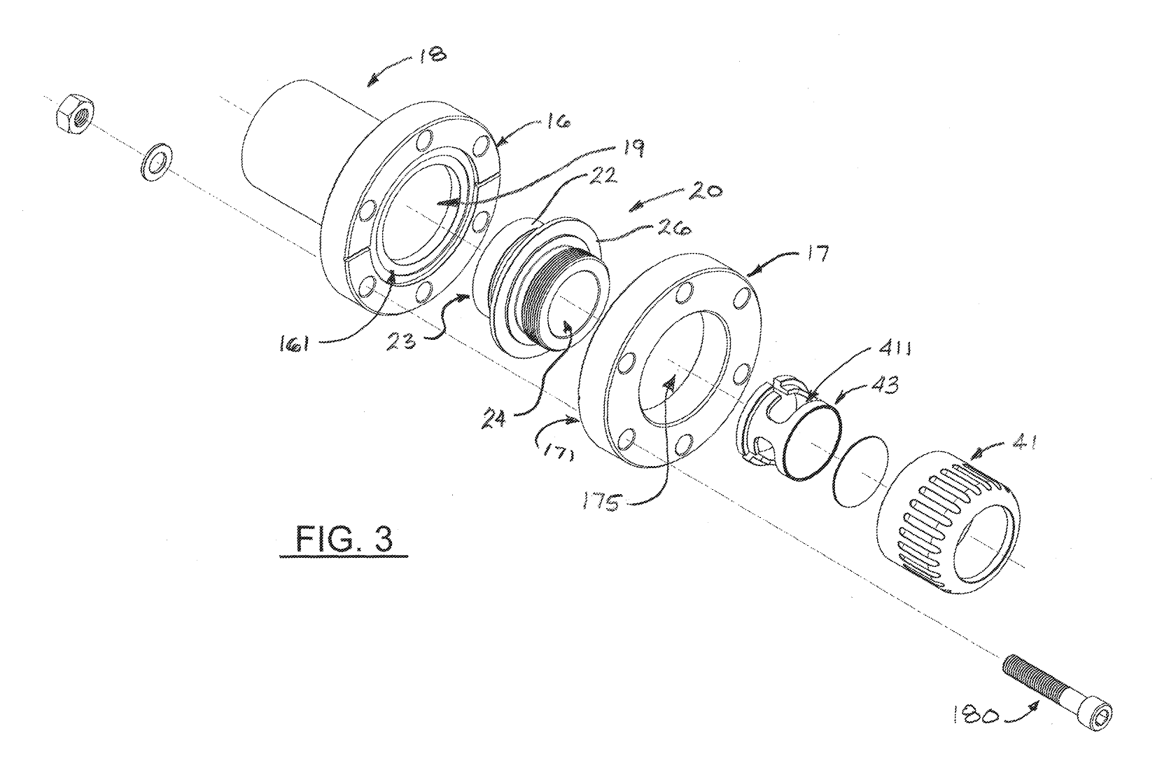

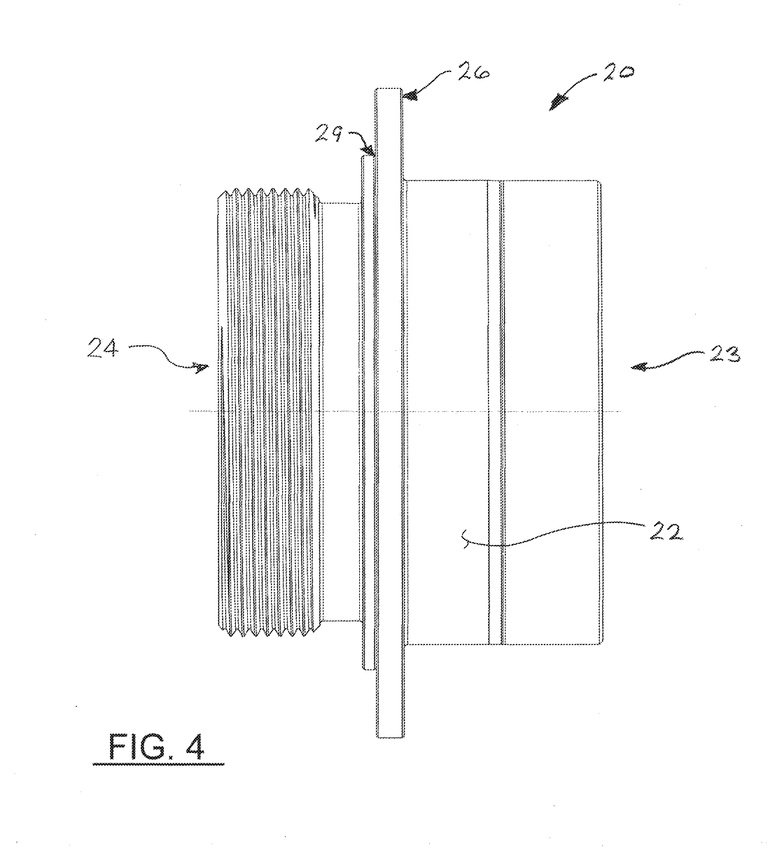

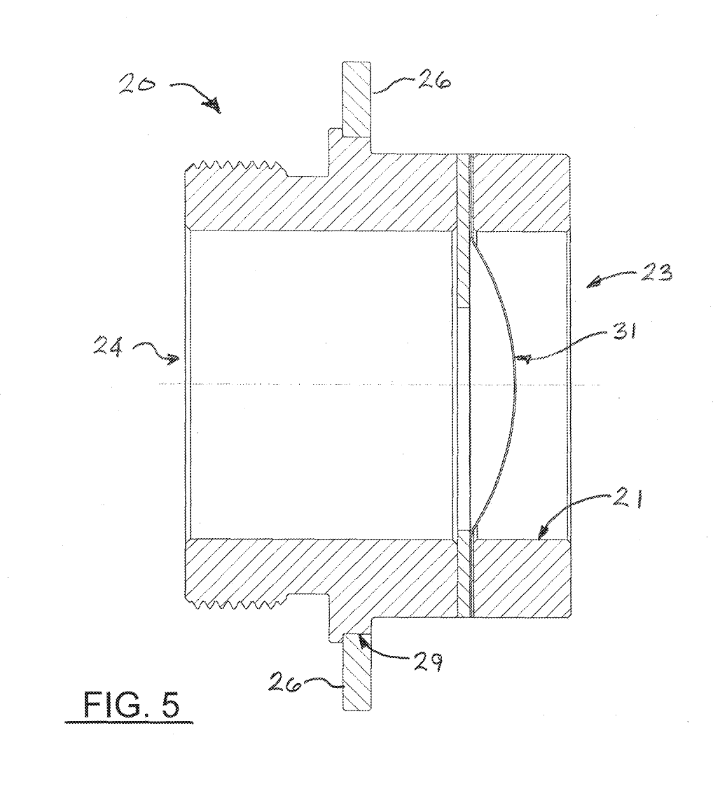

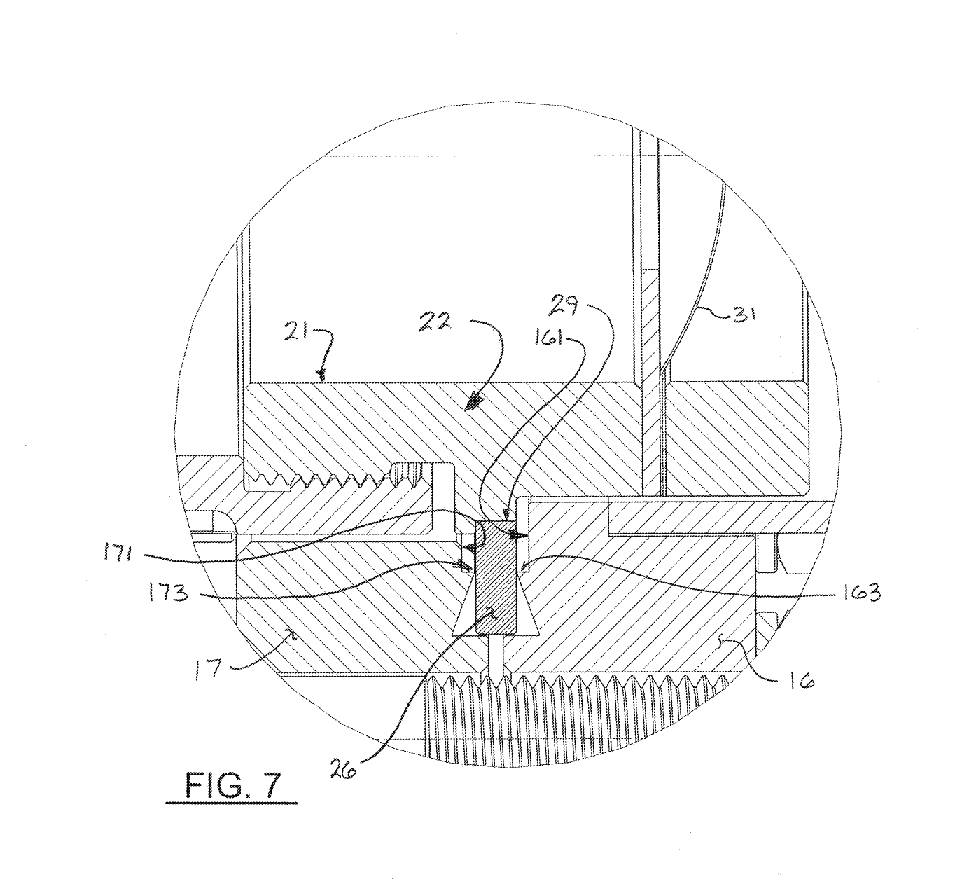

Referring now to FIGS. 3 through 8, there is shown a pressure relief conduit connection 18 to a HV or UHV containment vessel which includes an inboard metal seal flange 16. An improved burst disc assembly 20 embodiment of the present invention comprises a generally hollow cylindrical body 22 with an inlet opening 23 and an outlet opening 24, the body 22 configured to fit within the interior space 19 of the relief conduit 18. An exemplar relief conduit comprises a relief conduit of a nominal 1.5-inch outside diameter pipe having a nominal 0.06-inch wall thickness. The exemplar body has an outside diameter of 1.35 inches which allows it to fit inside the conduit. The improved burst disc assembly 20 may be scaled to fit applications in both larger and smaller diameter piping connections.

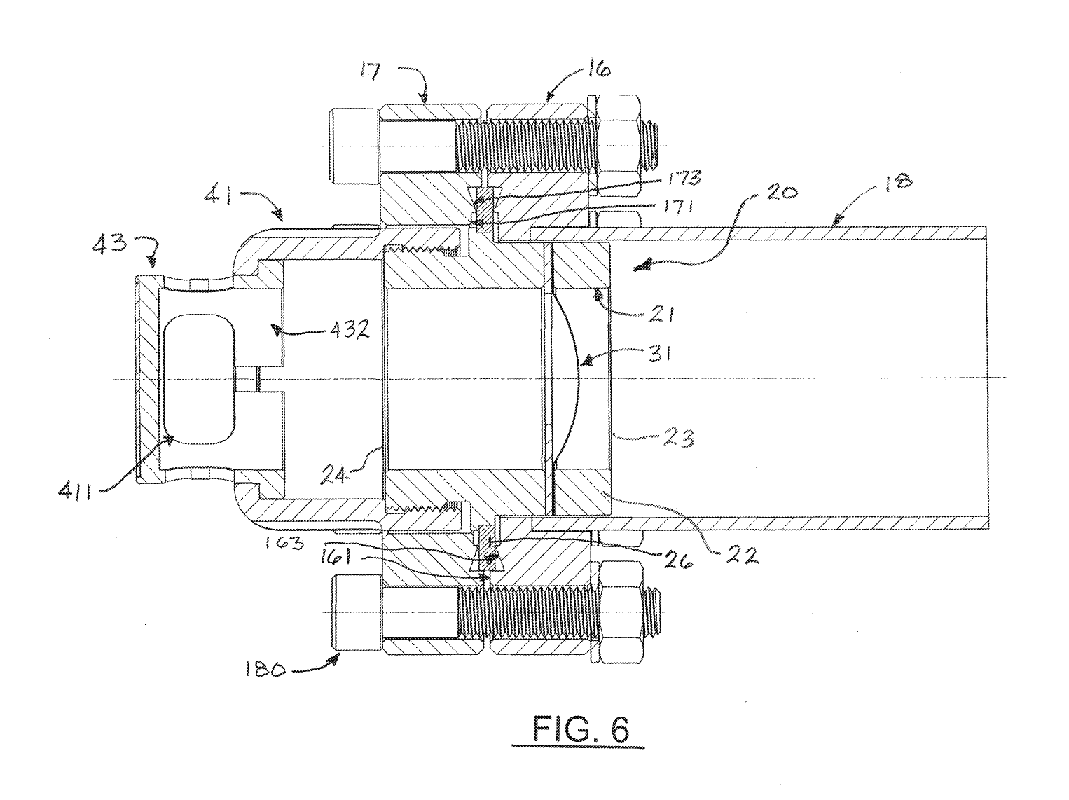

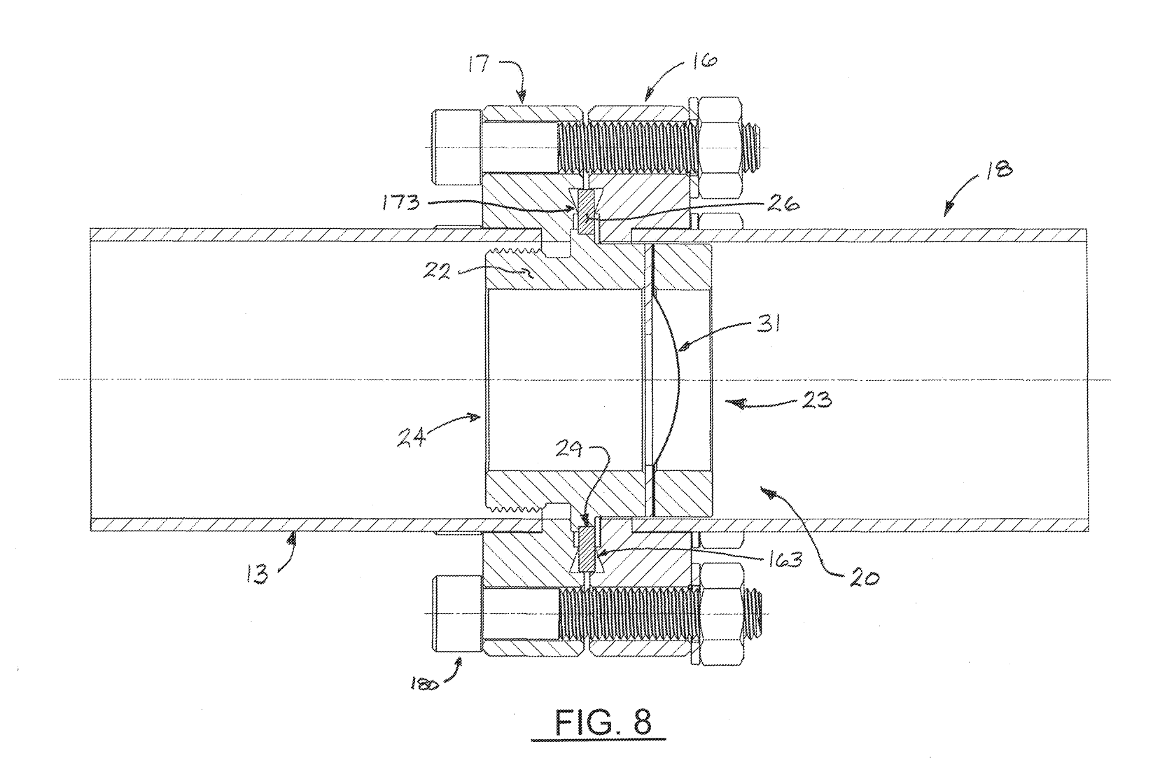

The illustrated pressure vacuum containment relief configuration in FIGS. 3 and 6 is shown venting to atmosphere as might be used when non-hazardous gasses are involved. The burst disc assembly 20 may also be used in closed venting configurations in which the vent conduit is directed to a receiving vessel to prevent release of potentially hazardous gasses. The design of the improved burst disc assembly may be installed in either configuration, requiring only a mating pair of metal seal flanges 16, 17 for installation, further enhancing the utility of the invention. FIG. 8 illustrates installation of the burst disc assembly 20 in a closed venting system in which the outboard piping 13 is directed to a secondary containment vessel or container.

The burst disc assembly 20 further includes a mounting structure 26 extending radially outwardly from the body 22. The mounting structure 26 is configured to be clamped between adjacent faces 161, 171 of inboard and outboard metal seal flanges 16, 17, respectively, which secure the burst disc assembly 20 in position within the relief conduit 18 against the pressure forces subjected on the burst disc membrane. The mounting structure 26 also seals the interface between the inboard and outboard metal seal flanges 16, 17.

The inboard and outboard seal flanges 16, 17, and the burst disc assembly body 22 are preferably formed from stainless steel, a preferred material in high vacuum applications. The mounting structure 26 is formed from a relatively soft metal material, such as oxygen free copper (OFE copper), which enables it to function as a sealing gasket between the inboard and outboard metal seal flanges 16, 17 to create a hermetic seal. The hermetic seal prevents the passage of gas molecules from the surrounding environment into the normal vacuum conditions within the relief conduit interior space 19. The seal flange faces 161, 171 each have a sealing structure 163, 173 encircling the internal opening in the flange face. The sealing structures 163, 173 deform the material of the gasket as the flanges are drawn together by clamping fasteners 180. The sealing structures 163, 173 may be in the form of a knife edge projecting from the flange face 161, 171. Both of the metal seal flanges are preferably in the form of a knife-edge encircling the conduit, the knife edge locally deforming the relatively softer copper material of the mounting structure 26 to assure a leak-tight seal capable of preventing the passage of gasses at the molecular level.

The mounting structure 26 is connected to the body 22 at a gasket bond 29 using a connection means that provides a hermetic seal and the mounting structure 26 and the body 22. Preferred means for bonding the preferred copper material of the mounting structure 26 to the stainless steel of the body 22 include fusing, brazing, welding, or other hermetically sealing method. The method must allow sufficient control of the weld beam input to accommodate the different melting points of the dissimilar materials of the preferred embodiment. An electron beam welding process has been shown to provide satisfactory structural bonding and sealing performance without distorting the stainless-steel body or the copper mounting structure to the point at which the sealing performance of the flanged connection is affected. The bond 29 is positioned adjacent to the body 22 in a location that is displaced slightly from the interface between the flange sealing structures 163, 173 and the mounting structure 26.

The body 22 includes an internal bore 21 connecting the inlet and outlet openings 23, 24 to allow the relief conduit 18 to vent to atmosphere. A burst membrane 31 is disposed within the internal bore 21 and joined to the body 22, preferably by welding, to prevent the passage of gas at molecular level through the internal bore past the membrane 31 while the membrane remains intact. Overpressure conditions in the containment vessel cause the material of the burst membrane to rupture, opening the vent path between the inlet and outlet openings 23, 24, and venting the containment vessel to atmosphere.

The burst disc assembly 20 may also include a protective cover 41 to protect the burst membrane 31 from unintentional contact with foreign objects outside of the containment vessel that could cause the membrane to rupture. The protective cover 41 is preferably connected to the body 22 adjacent to the outlet opening 24 and may extend outward of the outboard flange 17. The protective cover may be connected to the body 22 by a threaded connection or by any other means to secure the cover 41 to the body. The cover 41 is sized to permit it to extend through an opening 175 in the outboard flange so that it is exposed to the surrounding atmosphere or an exhaust conduit. The cover 41 may be provided with a plurality of vent openings 411 to permit the expulsion of gasses resulting from an overpressure actuation of the burst disc.

The protective cover 41 may be provided with a visual indicator 43 to signal that a rupture of the burst disc membrane 31 has occurred and that the burst disc assembly 20 requires replacement. In one embodiment, the indicator 43 is moveably positioned in the cover 41 and moveable between a normal position and a burst indicating position (shown in FIG. 6). In the normal position, the indicator 43 is substantially disposed within the cover 41 where it is not outwardly visible to an outside observer. An overpressure condition rupturing the burst disc pressurizes the volume inside of the indicator and overcomes the slight friction fit between the indicator and the cover. The pressure forces acting on the interior side 432 of the indicator 43 displace the indicator toward the burst indicating position. In this position, at least a portion of the indicator 43 projects outwardly from the cover 41 where it become visible to an outside observer indicating that an overpressure condition has occurred in the containment vessel and the burst disc assembly 20 requires replacement. The indicator 43 may be differently colored than the cover 41 to improve the visual indication.

Naturally, the invention is not limited to the foregoing embodiments, but it can also be modified in many ways without departing from the basic concepts. Changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. An improved burst disc assembly for use in high vacuum and ultra-high vacuum containment vessels, the assembly comprising:
a body having an external surface and internal passage therethrough connecting an inlet opening and an outlet opening;
a burst disc disposed within the internal passage between the inlet and outlet openings, the burst disc hermetically sealed within the internal passage;
a mounting gasket extending radially outwardly from the external surface of the body, the mounting gasket configured to support the burst disc assembly entirely within a pressure relief conduit fluidly connected to the containment vessel and to hermetically seal the burst disc assembly within the pressure relief conduit to preclude leakage into the containment vessel.

2. The burst disc assembly of claim 1, wherein the pressure relief conduit includes a pair of connection flanges being selectively separable and having adjacently disposed and generally parallel flange faces, each flange face having a sealing structure, the mounting gasket being positioned between the adjacently disposed faces.

3. The burst disc assembly of claim 2, wherein the connection flanges are vacuum service flanges and the sealing structure comprises a knife edge projecting from the flange face and engaging the mounting gasket.

4. The burst disc assembly of claim 3, wherein the mounting gasket is formed of a material having a hardness that is significantly less than the material hardness of the knife edges and the adjacently disposed faces.

5. The burst disc assembly of claim 4, wherein the mounting gasket material is copper and the adjacently disposed faces and the knife edges are formed from stainless steel.

6. The burst disc assembly of claim 1, wherein the mounting gasket is bonded to the body using a bonding method which creates a hermetic seal therebetween.

7. The burst disc assembly of claim 6, wherein the bonding method includes fusing, brazing, or welding.

8. The burst disc assembly of claim 1, further comprising a protective cover connected to the outlet opening and configured to prevent contact with the burst disc by rigid objects outside of the containment vessel, the protective cover further permitting the passage of gas from the containment vessel to the surrounding atmosphere upon rupture of the burst disc cause by an overpressure condition in the containment vessel.

9. The burst disc assembly of claim 8, wherein the protective cover further includes a moveable indicator configured for movement between a normal state and a burst state, movement from the normal to the burst state being effected by an overpressure condition in the containment vessel causing rupture of the burst disc.

10. A burst disc assembly for use in a pressure relief conduit for a high vacuum or ultra-high vacuum containment vessel, the assembly comprising:
a body having an external surface configured for insertion into the pressure relief conduit, the body having an inlet opening and an outlet opening connected by an internal passage;
a burst disc disposed within the internal passage between the inlet and outlet openings, the burst disc being hermetically sealed within the internal passage to prevent the passage of gas between the inlet opening and the outlet opening; and
a mounting structure extending radially outwardly from the body, the mounting structure configured to interface with adjacent flange faces disposed in the relief conduit by positioning the mounting structure between the adjacent flange faces thereby retaining the assembly in a fixed position within the relief conduit, the mounting structure interface with the adjacent flange faces hermetically sealing the interface to prevent the passage of gas into the relief conduit through the interface between the flange faces and the mounting structure, the mounting structure connection to the body further being hermetically sealed to preclude the passage of gas through an annular space between the external surface and the relief conduit.

11. The burst disc assembly of claim 10, wherein the adjacent flange faces in the relief conduit each have a sealing structure disposed thereon configured to interface with the mounting structure positioned between the adjacent flange faces.

12. The burst disc assembly of claim 11, wherein the mounting structure is formed of a material having a hardness that is significantly less than the material hardness of the adjacent flange faces.

13. The burst disc assembly of claim 12, wherein the mounting structure material is copper and the adjacent flange face material is a stainless steel.

14. The burst disc assembly of claim 12, wherein the mounting structure is bonded to the body using a bonding method which creates a hermetic seal therebetween.

15. The burst disc assembly of claim 14, wherein the bonding method includes fusing, brazing, or welding.

16. The burst disc assembly of claim 10, wherein the sealing structure comprises a knife edge projecting from the flange face and engaging the mounting gasket to hermetically seal the interface.

17. The burst disc assembly of claim 10, further comprising a protective cover connected to the outlet opening and configured to prevent contact with the burst disc by rigid objects outside of the containment vessel, the protective cover further permitting the passage of gas from the containment vessel to the surrounding atmosphere upon rupture of the burst disc cause by an overpressure condition in the containment vessel, the protective cover further including a moveable indicator configured for movement between a normal state and a burst state, movement from the normal to the burst state being effected by an overpressure condition in the containment vessel causing rupture of the burst disc.
